(19) United States
(12) Patent Application Publication
(10) Pub. No.: US 2023/0420809 A1
(43) Pub. Date: Dec. 28, 2023

(54) BATTERY AND BATTERY MODULE

(71) Applicant: TOYOTA JIDOSHA KABUSHIKI KAISHA, Toyota-shi (JP)

(72) Inventor: Ryo KAGAMI, Ichinomiya-shi (JP)

(73) Assignee: TOYOTA JIDOSHA KABUSHIKI KAISHA, Toyota-shi (JP)

(21) Appl. No.: 18/140,328

(22) Filed: Apr. 27, 2023

(30) Foreign Application Priority Data
Jun. 27, 2022 (JP) 2022-102546

(51) Int. Cl. H01M 50/54; H01M 50/105; H01M 50/178

(52) U.S. Cl. CPC H01M 50/54; H01M 50/105; H01M 50/178

(57) ABSTRACT

In a battery, each current collector tab includes a root portion, a connection portion, and an intermediate portion. Current collector tabs include a laminated connection portion in which the connection portions are laminated. A current collector terminal includes an inner surface facing a side surface portion of an electrode body, and a side surface disposed along an outer edge of the inner surface. A laminate film is disposed on the side surface. A main surface of the laminated connection portion is joined to the inner surface. In a plan view in an electrode body laminating direction, the current collector terminal includes a base portion including a first end portion corresponding to the position of the inner surface and a second end portion opposite to the first end portion, and a protruding portion protruding from the base portion to an opposite side of the base portion from the electrode body.

### CROSS-REFERENCE TO RELATED APPLICATION

This application claims priority to Japanese Patent Application No. 2022-102546 filed on Jun. 27, 2022, incorporated herein by reference in its entirety.

### BACKGROUND

### 1. Technical Field

The present disclosure relates to a battery and a battery module.

### 2. Description of Related Art

A battery such as a lithium ion secondary battery generally includes an electrode body having a positive electrode current collector, a positive electrode active material layer, an electrolyte layer, a negative electrode active material layer, and a negative electrode current collector. The electrode body is sealed with an exterior body. Electricity generated in the electrode body is led out from the inside of the exterior body to the outside thereof by a current collector terminal. For example, Japanese Patent No. 5550805 (JP 5550805 B) discloses a stacking or stacking/folding type electrode assembly of a positive electrode/separator/negative electrode structure. Also, FIG. 2 of JP 5550805 B discloses that multiple tabs (e.g., positive electrode tabs 40) are combined in a closely spaced configuration and connected to a lead (e.g., positive electrode lead 60). Furthermore, JP 5550805 B discloses that a laminate sheet (laminate film) is used as an exterior body. Similarly, Japanese Unexamined Patent Application Publication No. 2011-108623 (JP 2011-108623 A) and Japanese Unexamined Patent Application Publication No. 2020-115423 (JP 2020-115423 A) also disclose the use of a laminate film as an exterior body.

### SUMMARY

When multiple batteries (battery cells) are stacked and adjacent current collector terminals are joined together, stress may be generated at a joint portion of the current collector terminal and current collector tabs, which may deteriorate bondability between the current collector terminal and the current collector tabs or cause damage to the current collector tabs.

The present disclosure has been made in view of the above circumstances, and a main object thereof is to provide a battery in which stress is less likely to be generated at the joint portion of the current collector terminal and the current collector tabs even when multiple batteries are stacked and adjacent current collector terminals are joined together.

(1)

A battery includes: an electrode body; a plurality of current collector tabs extending from a side surface portion of the electrode body; a current collector terminal connected to the current collector tabs; and a laminate film housing the electrode body and the current collector tabs. Each of the current collector tabs includes a root portion that is an end portion on the electrode body side, a connection portion for connecting to the current collector terminal, and an intermediate portion connecting the root portion and the connection portion. The current collector tabs include a laminated connection portion in which the respective connection portions of the current collector tabs are laminated in a thickness direction. The current collector terminal includes an inner surface facing the side surface portion of the electrode body, and a side surface disposed along an outer edge of the inner surface. The laminate film is disposed on the side surface of the current collector terminal. A main surface of the laminated connection portion is joined to the inner surface. In a plan view in a laminating direction of the electrode body, the current collector terminal includes a base portion including a first end portion corresponding to a position of the inner surface and a second end portion opposite to the first end portion, and a protruding portion protruding from the base portion to an opposite side of the base portion from the electrode body.

(2)

In the battery according to (1), in a sectional view in the laminating direction of the electrode body, the intermediate portion may include a curved structure in which the intermediate portion is curved such that parts of the intermediate portion face each other.

(3)

In the battery according to (1) or (2), the current collector terminal may include a first protruding portion and a second protruding portion as the protruding portion; and in the plan view in the laminating direction of the electrode body, when a direction in which the electrode body and the current collector terminal face each other is D₁, a direction orthogonal to the direction D₁ is D₂, and an axis that is parallel to the direction D₁ and passes through a midpoint of the current collector terminal in the direction D₂ is AX, the first protruding portion may be disposed in one area of the current collector terminal partitioned by the axis AX, and the second protruding portion may be disposed in another area of the current collector terminal partitioned by the axis AX.

(4)

In a battery module in which multiple batteries are stacked, each of the batteries is the battery according to any one of (1) to (3).

(5)

In a battery module in which multiple batteries are stacked: each of the batteries is the battery according to (3); the battery module includes a battery A, a battery B, and a battery C as the batteries; the battery A, the battery B, and the battery C are stacked in succession; the first protruding portion of the battery A, the first protruding portion of the battery B, and the first protruding portion of the battery C are arranged so as to at least partially overlap each other in the plan view in the laminating direction of the electrode body; the second protruding portion of the battery A, the second protruding portion of the battery B, and the second protruding portion of the battery C are arranged so as to at least partially overlap each other in the plan view in the laminating direction of the electrode body; the first protruding portion of the battery B is joined to the first protruding portion of the battery A, and is not joined to the first protruding portion of the battery C; and the second protruding portion of the battery B is not joined to the second protruding portion of the battery A, and is joined to the second protruding portion of the battery C.

The present disclosure has the effect of being able to provide a battery in which stress is less likely to be generated at the joint portion of the current collector terminal and the current collector tabs even when multiple batteries are stacked.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view illustrating a battery in the present disclosure;

FIG. 2A is a schematic plan view illustrating the battery in the present disclosure;

FIG. 2B is a schematic plan view illustrating the battery in the present disclosure;

FIG. 2C is a schematic side view illustrating the battery in the present disclosure;

FIG. 3 is a sectional view taken along line A-A in FIG. 2B;

FIG. 4 is a schematic plan view illustrating a current collector terminal and surroundings thereof in the present disclosure;

FIG. 5A is a schematic perspective view illustrating a battery of the related art;

FIG. 5B is a schematic side view illustrating the battery of the related art;

FIG. 6A is a schematic perspective view illustrating the battery in the present disclosure;

FIG. 6B is a schematic side view illustrating the battery in the present disclosure;

FIG. 7 is a schematic plan view illustrating a current collector terminal in the present disclosure;

FIG. 8 is a schematic perspective view illustrating the current collector terminal in the present disclosure;

FIG. 9 is a schematic sectional view illustrating an electrode body in the present disclosure;

FIG. 10A is a schematic perspective view illustrating a method for manufacturing the battery in the present disclosure;

FIG. 10B is a schematic perspective view illustrating the method for manufacturing the battery in the present disclosure;

FIG. 10C is a schematic perspective view illustrating the method for manufacturing the battery in the present disclosure;

FIG. 10D is a schematic perspective view illustrating the method for manufacturing the battery in the present disclosure;

FIG. 10E is a schematic perspective view illustrating the method for manufacturing the battery in the present disclosure;

FIG. 11 is a schematic perspective view illustrating a battery module in the present disclosure; and

FIG. 12 is a schematic perspective view illustrating the battery module in the present disclosure.

### DETAILED DESCRIPTION OF EMBODIMENTS

A battery and a battery module according to the present disclosure will be described in detail below with reference to the drawings. Each drawing shown below is schematically shown, and the size and shape of each part are appropriately exaggerated for easy understanding. Moreover, hatching of each part may be omitted as appropriate.

### A. Battery

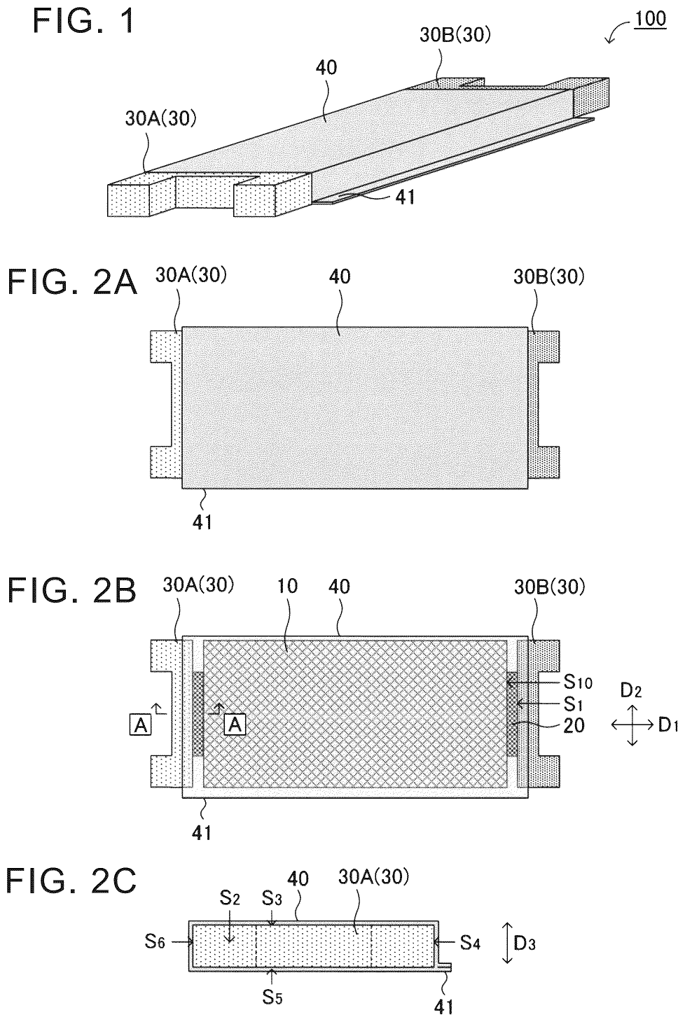

FIG. 1 is a schematic perspective view illustrating the battery in the present disclosure. FIGS. 2A and 2B are each a schematic plan view illustrating the battery in the present disclosure, and FIG. 2C is a schematic side view illustrating the battery in the present disclosure. As shown in FIG. 1 and FIGS. 2A, 2B, and 2C, the battery 100 includes an electrode body 10, a plurality of current collector tabs 20 extending from a side surface portion S₁₀ of the electrode body 10, current collector terminals 30 (first current collector terminal 30A and second current collector terminal 30B) connected to the current collector tabs 20, and a laminate film 40 housing the electrode body 10 and the current collector tabs 20.

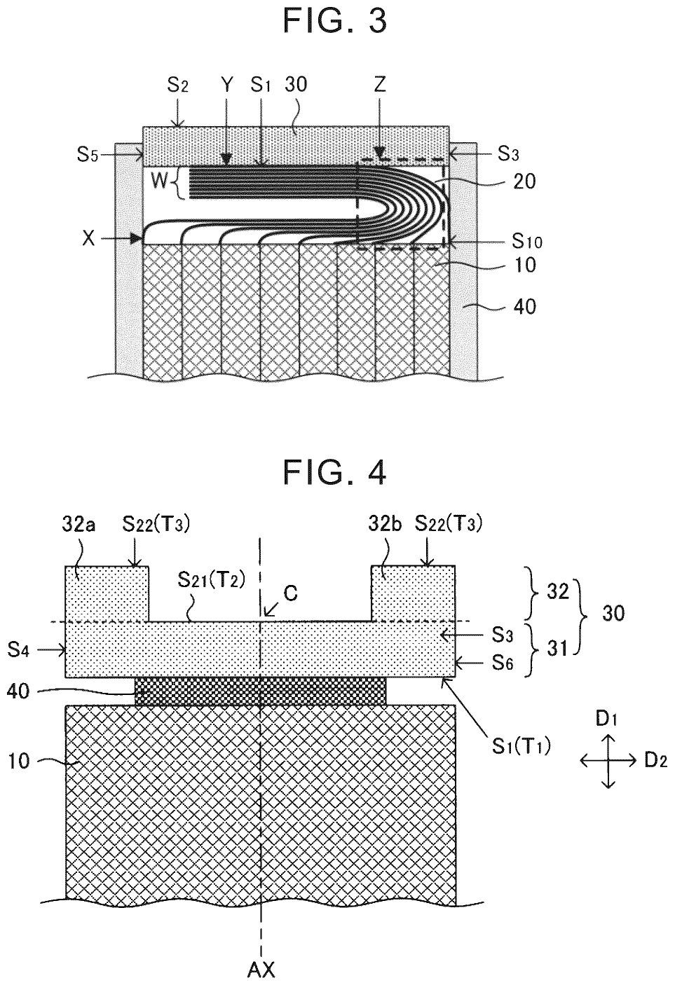

FIG. 3 is a sectional view taken along line A-A in FIG. 2B. As shown in FIG. 3, each of the current collector tabs 20 includes a root portion X that is an end portion on the electrode body 10 side, a connection portion Y for connecting to the current collector terminal 30, and an intermediate portion Z that connects the root portion X and the connection portion Y. The current collector tabs 20 have a laminated connection portion W in which the respective connection portions Y of the current collector tabs 20 are laminated in the thickness direction (up-down direction in FIG. 3). The current collector terminal 30 includes an inner surface S₁ facing the side surface portion S₁₀ of the electrode body 10, an outer surface S₂ opposite to the inner surface S₁, and four side surfaces (S₃, S₄, S₅, S₆) arranged along an outer edge of the inner surface S₁. Note that the side surface S₄ and the side surface S₆ are not shown in FIG. 3. As shown in FIG. 2C, a laminate film 40 is disposed on the four side surfaces S₃ to S₆. As shown in FIG. 3, a main surface of the laminated connection portion W is joined to the inner surface S₁ of the current collector terminal 30.

FIG. 4 is a schematic plan view illustrating the current collector terminal and surroundings thereof in the present disclosure. As shown in FIG. 4, the current collector terminal 30 has a base portion 31 including a first end portion T₁ corresponding to the position of the inner surface S₁ and a second end portion T₂ opposite to the first end portion T₁, and a protruding portion 32 protruding from the base portion 31 to the opposite side of the base portion 31 from the electrode body 10.

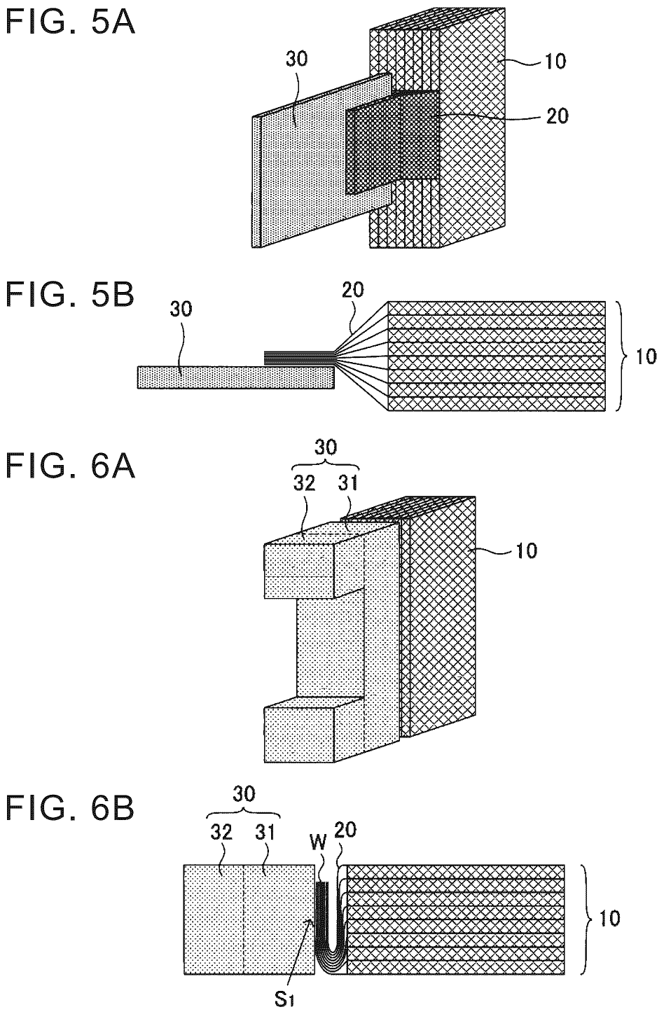

According to the present disclosure, by using a predetermined current collector terminal, a battery in which, even when multiple batteries are stacked and adjacent current collector terminals are joined together, stress is less likely to be generated at the joint portion of the current collector terminal and the current collector tabs is provided. FIG. 5A is a schematic perspective view illustrating a battery of the related art, and FIG. 5B is a schematic side view of the battery shown in FIG. 5A viewed from the lower side of the drawing. FIG. 6A is a schematic perspective view illustrating a battery in the present disclosure, and FIG. 6B is a schematic side view of the battery shown in FIG. 6A viewed from the lower side of the drawing. As shown in FIGS. 5A and 5B, in the battery of the related art, the joint portion of the current collector terminal 30 and the current collector tabs 20 is disposed on a main surface of the current collector terminal 30 (surface the normal direction of which coincides with the thickness direction). Since the current collector terminal 30 is thin, the positional change of the current collector terminal 30 in the thickness direction is large when stacking the batteries. As a result, large stress is generated at the joint portion of the current collector terminal 30 and the current collector tabs 20, and there is a possibility that bondability between the current collector terminal and the current collector tabs deteriorates or the current collector tabs are damaged. On the other hand, as shown in FIGS. 6A and 6B, in the present disclosure, the current collector terminal 30 having the inner surface S₁ with which the main surface of the laminated connection portion W can be in surface contact is used. That is, since the current collector terminal 30 is thick, the positional change of the current collector terminal 30 in the thickness direction is small when stacking the batteries. As a result, it is possible to suppress the generation of large stress at the joint portion of the current collector terminal 30 and the current collector tabs 20. Furthermore, since the current collector terminal 30 has the protruding portion 32, there is an advantage that the positional change of the current collector terminal 30 in the thickness direction when stacking the batteries is small compared to a case where the current collector terminal 30 does not have the protruding portion 32. In particular, as will be described later, when the current collector tabs 20 have a curved structure, even when stress is generated at the joint portion of the current collector terminal 30 and the current collector tabs 20, the stress is readily dispersed by the curved structure.

### 1. Battery Configuration

The battery in the present disclosure includes the electrode body, the current collector tabs extending from the side surface portion of the electrode body, the current collector terminal connected to the current collector tabs, and the laminate film housing the electrode body and the current collector tabs.

### (1) Electrode Body

The electrode body in the present disclosure includes a power generation unit generally having a positive electrode current collector, a positive electrode active material layer, an electrolyte layer, a negative electrode active material layer, and a negative electrode current collector in this order in the thickness direction. Although the shape of the electrode body is not particularly limited, having, for example, a top surface portion, a bottom surface portion opposite to the top surface portion, and four side surface portions connecting the top surface portion and the bottom surface portion is desirable. The shape of the top surface portion is not particularly limited, but examples thereof include quadrilaterals such as squares, rectangles, rhombuses, trapezoids, and parallelograms. The shape of the top surface portion may be a polygonal shape other than a quadrilateral, or may be a shape having a curve such as a circular shape. Also, the shape of the bottom surface portion is the same as the shape of the top surface portion. The shape of the side surface portion is not particularly limited, but examples thereof include quadrilaterals such as squares, rectangles, rhombuses, trapezoids, and parallelograms.

### (2) Current Collector Tabs

The current collector tabs in the present disclosure are arranged so as to extend from the side surface portion of the electrode body. The term “side surface portion of the electrode body” refers to a portion that constitutes the electrode body and the normal direction of which intersects the laminating direction of the electrode body. For example, in FIG. 3, the normal direction (up-down direction in the drawing) of the side surface portion S₁₀ to of the electrode body 10 is orthogonal to the laminating direction (right-left direction in the drawing) of the electrode body 10. Further, the “laminating direction of the electrode body” refers to the thickness direction of each layer constituting the electrode body.

As shown in FIG. 3, each of the current collector tabs 20 includes a root portion X that is an end portion on the electrode body 10 side, a connection portion Y for connecting to the current collector terminal 30, and an intermediate portion Z that connects the root portion X and the connection portion Y. The root portion X is an end portion (boundary portion) of the current collector tab 20 on the electrode body 10 side. The connection portion Y is a portion for connecting to the current collector terminal 30, and is a portion that constitutes a laminated connection portion W, which will be described later. The intermediate portion Z is a portion connecting the root portion X and the connection portion Y. In the present disclosure, the current collector tabs have a laminated connection portion in which the respective connection portions of the current collector tabs are laminated in the thickness direction. In FIG. 3, the respective connection portions Y of the current collector tabs 20 are laminated in the thickness direction of the current collector tab 20, thereby forming the laminated connection portion W. In the laminated connection portion W, the connection portions Y are joined to each other (fixed to each other).

As shown in FIG. 3, in a sectional view in the laminating direction of the electrode body 10, it is desirable that the intermediate portion Z has a curved structure (area indicated by a broken line) in which the intermediate portion Z is curved such that parts of the intermediate portion Z face each other. In FIG. 3, the intermediate portion Z of a rightmost current collector tab 20 among the current collector tabs 20 does not have the curved structure because the parts of the intermediate portion Z do not face each other, whereas the intermediate portions Z of the other current collector tabs 20 all have the curved structure. In this manner, it is desirable that the intermediate portion Z of at least one current collector tab 20 among the current collector tabs 20 has the curved structure. In the curved structure, parts of the intermediate portion Z facing each other may be arranged so as to be in direct contact with each other, or may be arranged with a space therebetween. As shown in FIG. 3, it is desirable that the intermediate portions Z of the current collector tabs 20 are curved in a U-shape.

### (3) Current Collector Terminal

The current collector terminal in the present disclosure has the inner surface facing the side surface portion of the electrode body, and the side surface disposed along the outer edge of the inner surface. The shape of the inner surface is not particularly limited, but examples thereof include quadrilaterals such as squares, rectangles, rhombuses, trapezoids, and parallelograms. The number of the side surfaces is, for example, more than one. Also, the number of the side surfaces depends, for example, on the shape of the outer edge of the inner surface. For example, when the shape of the outer edge of the inner surface is a quadrilateral, the current collector terminal may have four side surfaces. Also, the current collector terminal may have an outer surface opposite to the inner surface. The inner surface generally corresponds to a surface within an area sealed with the laminate film. The outer surface generally corresponds to a surface outside the area sealed with the laminate film. Each of the base portion and the protruding portion, which will be described later, may have an outer surface opposite to the inner surface. The inner surface, the side surface, and the outer surface may each be flat or curved.

As shown in FIG. 4, the current collector terminal 30 has a base portion 31 and a protruding portion 32 in a plan view. The base portion 31 includes the first end portion T₁ corresponding to the position of the inner surface S₁ and the second end portion T₂ opposite to the first end portion T₁. In FIG. 4, the second end portion T₂ corresponds to the position of the outer surface S₂₁. As shown in FIG. 4, a direction in which the electrode body 10 and the current collector terminal 30 face each other is D₁, and a direction orthogonal to the direction D₁ is D₂. The base portion 31 corresponds to a portion from the position of the first end portion T₁ to the position of the second end portion T₂ in the direction D₁. The base portion 31 of the current collector terminal 30 may include an inner surface S₁, an outer surface S₂ opposite to the inner surface S₁, and four side surfaces (S₃, S₄, S₅, S₆) arranged along the outer edge of the inner surface S₁. Examples of the shape of the base portion 31 include a rectangular parallelepiped. On the other hand, in the direction D₁, the protruding portion 32 is a portion protruding from the base portion 31 to the opposite side of the base portion 31 from the electrode body 10. In FIG. 4, the protruding portion 32 has a third end portion T₃ corresponding to the position of the outer surface S₂₂. The third end portion T₃ is located outside of the second end portion T₂ (farther away from the electrode body 10 than the second end portion) in the direction D₁. Examples of the shape of the protruding portion 32 include a rectangular parallelepiped. It is desirable that the protruding portion 32 is formed in succession from the base portion 31.

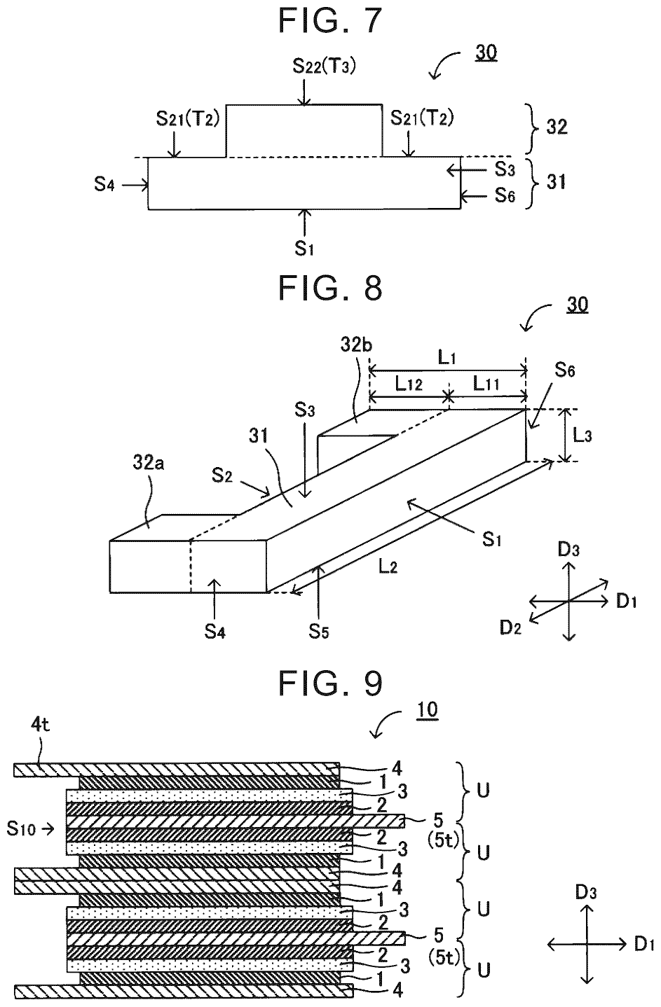

The current collector terminal in the present disclosure may have a plurality of protruding portions. In FIG. 4, the current collector terminal 30 has a first protruding portion 32a and a second protruding portion 32b as the protruding portion 32. As shown in FIG. 4, an axis that is parallel to the direction D₁ and passes through the midpoint C of the current collector terminal 30 in the direction D₂ is referred to as AX. It is desirable that the first protruding portion 32a is disposed in one area of the current collector terminal 30 partitioned by the axis AX, and the second protruding portion 32b is disposed in the other area of the current collector terminal 30 partitioned by the axis AX. As shown in FIG. 4, it is desirable that the current collector terminal 30 has a U-shape. In addition, as shown in FIG. 7, the current collector terminal 30 may have one protruding portion 32. The current collector terminal 30 shown in FIG. 7 has a T-shape.

As shown in FIG. 8, the length of the current collector terminal 30 in the direction D₁ is L₁, the length of the current collector terminal 30 in the direction D₂ is L₂, and the length of the current collector terminal 30 in the direction D₃ (direction orthogonal to both D₁ and D₂) is L₃. Also, the length of the base portion in the direction D₁ is L₁₁, and the length of the protruding portion in the direction D₁ is L₁₂. The ratio of L₁₂ to L₁₁ (L₁₂/L₁₁) is, for example, 0.5 or more and five or less, or may be one or more and three or less. L₁₁ and L₁₂ are each, for example, 0.5 cm or more and 5 cm or less. L₂ may be greater than L₁. The ratio of L₂ to L₁ (L₂/L₁) is, for example, two or more, and may be five or more, or may be 10 or more. L₂ may be greater than L₃. The ratio of L₂ to L₃ (L₂/L₃) is, for example, five or more, and may be 10 or more, or may be 50 or more. L₁ may be greater than L₃. The ratio of L₁ to L₃ (L₁/L₃) is, for example, two or more, and may be five or more, or may be 10 or more.

Although not particularly shown, the length of the electrode body in the direction D₁ is L_{X}, the length of the electrode body in the direction D₂ is L_{Y}, and the length of the electrode body in the direction D₃ is L_{Z}. The ratio of L₁ to L_{X} (L₁/L_{X}) is not particularly limited. The ratio of L₂ to L_{Y} (L₂/L_{Y}) is, for example, 0.8 or more, and may be 0.9 or more, or may be 0.95 or more. L₂/L_{Y} is, for example, 1.0 or less. The ratio of L₃ to L_{Z} (L₃/L_{Z}) is, for example, 0.8 or more, and may be 0.9 or more, or may be 0.95 or more. L₃/L_{Z} is, for example, 1.0 or less.

When the battery is viewed from the current collector terminal side in side view, the inner surface of the current collector terminal and the side surface portion of the electrode body are arranged so as to overlap each other. An area where the inner surface of the current collector terminal and the side surface portion of the electrode body overlap is referred to as an overlapping area. The ratio of the area S_{B} of the overlapping area to the area S_{A} of the side surface portion of the electrode body (S_{B}/S_{A}) is, for example, 80% or more, and may be 90% or more, or may be 95% or more. On the other hand, S_{B}/S_{A} is 100% or less.

As shown in FIG. 3, the main surface of the laminated connection portion W is joined to the inner surface S₁ of the current collector terminal 30. The term “main surface of the laminated connection portion W” refers to a surface that constitutes the laminated connection portion W and the normal direction of which coincides with the thickness direction of the connection portion Y. The main surface of the laminated connection portion W may be directly in contact with and joined to the inner surface S₁, or may be joined via another member (for example, a conductive layer). The inner surface S₁ of the current collector terminal 30 and the laminated connection portion W are generally joined to each other (fixed to each other).

### (4) Laminate Film

The laminate film in the present disclosure houses the electrode body and the current collector tabs. In FIG. 2B, the laminate film 40 covers the electrode body 10 and the current collector tabs 20. As shown in FIGS. 2B and 2C, the laminate film 40 partially covers the side surfaces S₃ to S₆ of the current collector terminal 30. As shown in FIG. 2C, the laminate film 40 is disposed on each of the side surfaces S₃ to S₆. Each side surface and the laminate film may be in direct contact with each other, or may be arranged via another member (for example, a resin layer that improves adhesion). On the other hand, as shown in FIG. 1, along the direction D₁ in which the electrode body 10 and the current collector terminal 30 face each other, a seal portion 41 in which the laminate films 40 are fused to each other is disposed.

### 2. Member of Battery

The battery in the present disclosure includes at least the electrode body, the current collector tab, the current collector terminal, and the laminate film.

The electrode body in the present disclosure includes the power generation unit generally having the positive electrode current collector, the positive electrode active material layer, the electrolyte layer, the negative electrode active material layer, and the negative electrode current collector in this order in the thickness direction. The electrode body generally has multiple power generation units laminated in the thickness direction. For example, the electrode body 10 shown in FIG. 9 includes the power generation units U laminated in the thickness direction (direction D₃). Each power generation unit U has the positive electrode current collector 4, the positive electrode active material layer 1, the electrolyte layer 3, the negative electrode active material layer 2, and the negative electrode current collector 5 in this order in the thickness direction (direction D₃). Adjacent power generation units U share one negative electrode current collector 5.

The positive electrode active material layer contains at least a positive electrode active material. The positive electrode active material layer may further contain at least one of a conductive material, an electrolyte and a binder. Examples of the positive electrode active material include oxide active material such as LiNi_{1/3}Co_{1/3}Mn_{1/3}O₂. Examples of the conductive material include carbon material. The electrolyte may be a solid electrolyte or a liquid electrolyte (electrolyte solution). The solid electrolyte may be an organic solid electrolyte such as a gel electrolyte, or an inorganic solid electrolyte such as an oxide solid electrolyte or a sulfide solid electrolyte. Examples of the binder include a rubber-based binder and a fluoride-based binder.

The negative electrode active material layer contains at least a negative electrode active material. The negative electrode active material layer may further contain at least one of a conductive material, an electrolyte and a binder. Examples of the negative electrode active material include metal active material such as Li and Si, carbon active material such as graphite, and oxide active material such as Li₄Ti₅O₁₂. The conductive material, the electrolyte and the binder are similar to those described above. The electrolyte layer is disposed between the positive electrode active material layer and the negative electrode active material layer and contains at least an electrolyte. The electrolyte may be a solid electrolyte or a liquid electrolyte. The electrolyte is similar to those described above. The electrolyte layer may have a separator.

The positive electrode current collector collects current from the positive electrode active material layer. Examples of the material of the positive electrode current collector include metals such as aluminum, SUS, and nickel. Examples of the shape of the positive electrode current collector include a foil shape. The negative electrode current collector collects current from the negative electrode active material layer. Examples of the material of the negative electrode current collector include metals such as copper, SUS, and nickel. Examples of the shape of the negative electrode current collector include a foil shape.

The battery in the present disclosure includes a positive electrode tab and a negative electrode tab as current collector tabs. As shown in FIG. 9, the positive electrode tab 4t extends from the side surface portion S₁₀ of the electrode body 10 in a direction intersecting with the laminating direction (direction D₃) of the electrode body 10. Further, as shown in FIG. 9, the positive electrode tab 4t may be formed in succession from the positive electrode active material layer 1. When viewed from the laminating direction (direction D₃) of the electrode body 10, the positive electrode tab 4t is disposed at a position where the positive electrode tab 4t does not overlap with the positive electrode active material layer 1. Further, in FIG. 9, the negative electrode tab 5t extends from the side surface portion of the electrode body 10 in a direction intersecting with the laminating direction (direction D₃) of the electrode body 10. Since the details of the negative electrode tab are similar to those of the positive electrode tab, description thereof is omitted here. As shown in FIG. 9, the positive electrode tab 4t may extend from one of the side surface portions of the electrode body 10, and the negative electrode tab 5t may extend from the other one of the side surface portions of the electrode body 10 (double-side tab structure). On the other hand, although not particularly shown, the positive electrode tab and the negative electrode tab may extend from the same side surface portion of the electrode body (single-side tab structure).

The current collector terminal in the present disclosure is electrically connected to the current collector tab in the electrode body. Examples of the shape of the current collector terminal include a plate shape. Further, examples of the material of the current collector terminal include metals such as Al and SUS.

The laminate film in the present disclosure has at least a structure in which a heat-fusion layer and a metal layer are laminated. Moreover, the laminate film may have the heat-fusion layer, the metal layer and a resin layer in this order along the thickness direction. Examples of the material of the heat-fusion layer include an olefin-based resin such as polypropylene (PP) and polyethylene (PE). Examples of the material of the metal layer include aluminum, aluminum alloy, and stainless steel. Examples of the material of the resin layer include polyethylene terephthalate (PET) and nylon. The thickness of the heat-fusion layer is, for example, 40 μm or more and 100 μm or less. The thickness of the metal layer is, for example, 30 μm or more and 60 μm or less. The thickness of the resin layer is, for example, 20 μm or more and 60 μm or less. The thickness of the laminate film is, for example, 80 μm or more and 250 μm or less.

The battery in the present disclosure is typically a lithium ion secondary battery. Applications of the battery include, for example, a power source for vehicles such as hybrid electric vehicles (HEVs), plug-in hybrid electric vehicles (PHEVs), battery electric vehicles (BEVs), gasoline vehicles, and diesel vehicles. In particular, it is desirable that the battery is used as a drive power source for hybrid electric vehicles (HEVs), plug-in hybrid electric vehicles (PHEVs), or battery electric vehicles (BEVs). Also, the battery in the present disclosure may be used as a power source for mobile bodies other than vehicles (for example, railroads, ships, and aircraft), and may be used as a power source for electric products such as an information processing device.

### 3. Method for Manufacturing Battery

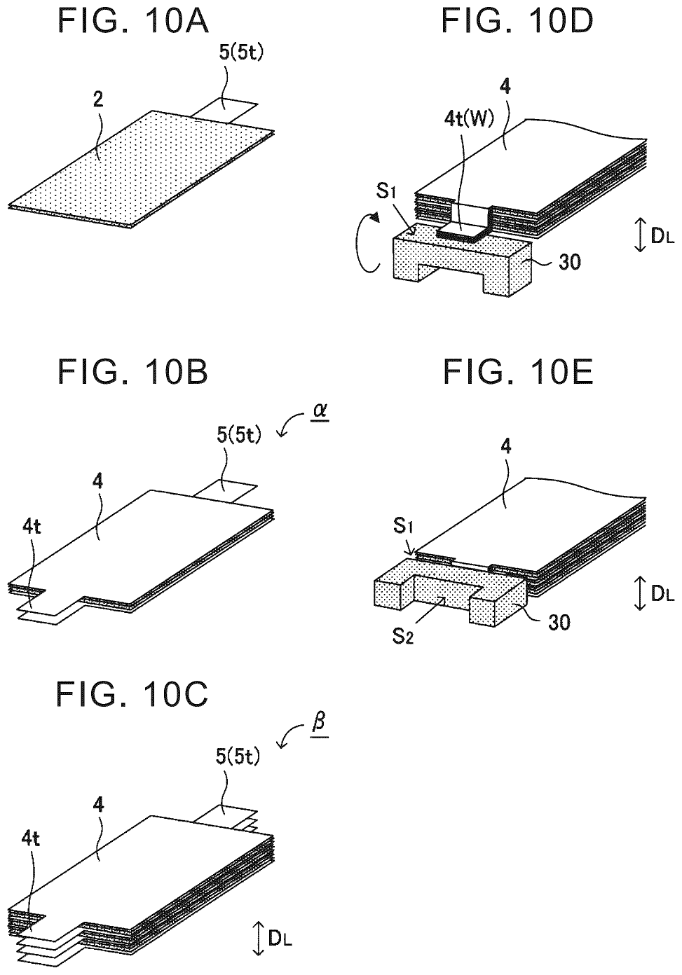

A method for manufacturing the battery in the present disclosure is not particularly limited as long as it is a method capable of manufacturing the battery described above. FIGS. 10A, 10B, 10C, 10D, and 10E are each a schematic perspective view illustrating the method for manufacturing the battery in the present disclosure. First, as shown in FIG. 10A, the negative electrode active material layers 2 are formed on opposite sides of the negative electrode current collector 5. Examples of the method for forming the negative electrode active material layer include a method of applying a slurry containing the material of the negative electrode active material layer onto the negative electrode current collector and drying the slurry. Next, as shown in FIG. 10B, an electrolyte layer (not shown), a positive electrode active material layer (not shown), and a positive electrode current collector 4 are arranged on each of the two negative electrode active material layers 2 to obtain a laminated body α.

After that, as shown in FIG. 10C, multiple laminated bodies a are laminated in the laminating direction D_{L} to produce a laminated body β. Next, as shown in FIG. 10D, the tips of the positive electrode tabs 4t are joined together to produce a laminated connection portion W, and the main surface of the laminated connection portion W is joined to the inner surface S₁ of the current collector terminal 30. Examples of the method for producing the laminated connection portion W include a method using welding such as laser welding and electron beam welding, a method using conductive paste, and a method using solder. The method for joining the main surface of the laminated connection portion W and the inner surface S₁ of the current collector terminal 30 is also the same as the method for producing the laminated connection portion W. Next, as shown in FIG. 10E, the current collector terminal 30 is rotated so that the normal direction of the inner surface S₁ and the outer surface S₂ of the current collector terminal 30 is orthogonal to the laminating direction D_{L}. After that, the negative electrode tab (not shown) is also subjected to the same treatment, and the obtained member is covered with a sheet of laminate film so that a part of the two current collector terminals facing each other (at least, the outer surface of each of the current collector terminals) is exposed, to thereby obtain a battery.

### B. Battery Module

FIG. 11 is a schematic perspective view illustrating the battery module in the present disclosure. In the battery module 200 shown in FIG. 11, multiple batteries 100 are stacked in the laminating direction D_{L} of the electrode body.

According to the present disclosure, by using the battery described in “A. Battery” above, a battery module in which, even when adjacent batteries are joined together, stress is less likely to be generated at the joint portion of the current collector terminal and the current collector tabs is provided.

It is desirable that the battery module in the present disclosure has three or more batteries. The three batteries stacked in succession are each referred to as battery A, battery B, and battery C. For example, the Nth (N≥1) battery from the top can be the battery A, the battery immediately below the battery A can be the battery B, and the battery immediately below the battery B can be the battery C.

For example, among the batteries 100 shown in FIG. 11, the uppermost battery 100 is the battery A, the battery 100 immediately below the battery A is the battery B, and the battery 100 immediately below the battery B is the battery C. In FIG. 11, the first protruding portion 32a of the battery A, the first protruding portion 32a of the battery B, and the first protruding portion 32a of the battery C are arranged so as to at least partially overlap each other in a plan view in the laminating direction D_{L} of the electrode body. Similarly, in FIG. 11, the second protruding portion 32b of the battery A, the second protruding portion 32b of the battery B, and the second protruding portion 32b of the battery C are arranged so as to at least partially overlap each other in the plan view in the laminating direction D_{L} of the electrode body.

In FIG. 11, the battery B (second battery 100 from the top) is used as a reference. It is desirable that the first protruding portion 32a of the battery B is joined to the first protruding portion 32a of the battery A (the uppermost battery 100), and is not joined to the first protruding portion 32a of the battery C (the third battery 100 from the top). It is desirable that the second protruding portion 32b of the battery B is not joined to the second protruding portion 32b of the battery A (the uppermost battery 100), and is joined to the second protruding portion 32b of the battery C (the third battery 100 from the top). Thus, it is possible to effectively suppress deformation of the current collector terminal by satisfying the following in the laminating direction D_{L} of the electrode body: (i) the joint portion of the adjacent first protruding portions 32a and the non-joining portion of the adjacent first protruding portions 32a are arranged alternately; (ii) the joint portion of the adjacent second protruding portions 32b and the non-joining portion of the adjacent second protruding portions 32b are arranged alternately; and (iii) the cycle of the joint portion and the non-joining portion in the first protruding portions 32a is offset from the cycle of the joint portion and the non-joining portion of the second protruding portions 32b.

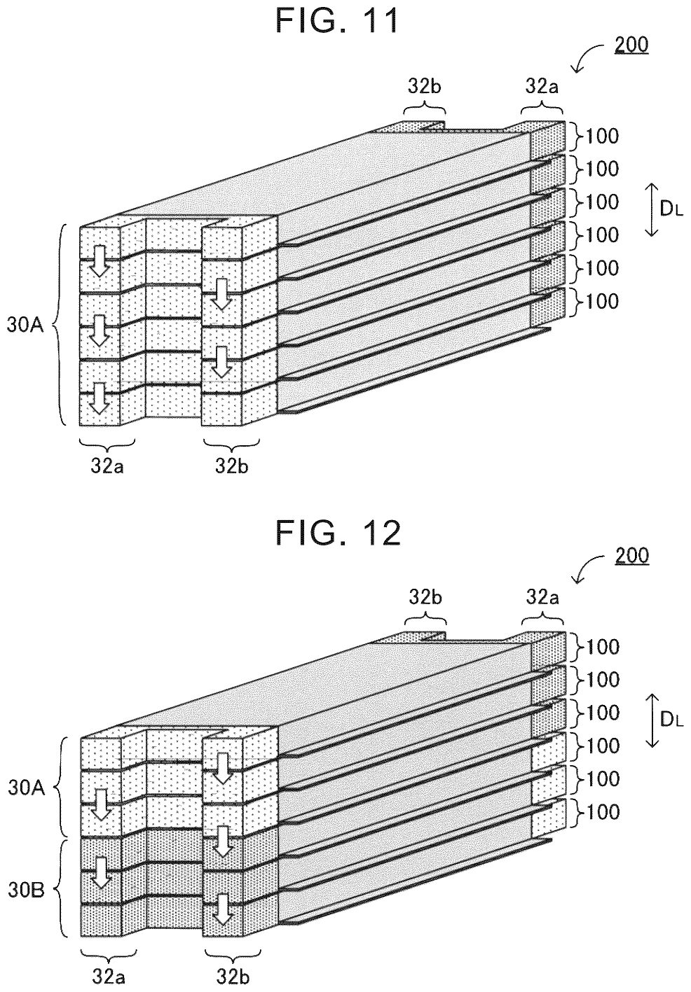

Further, in FIG. 11, multiple first current collector terminals 30A are arranged so as to overlap each other in the laminating direction D_{L} of the electrode body. In this case, the batteries 100 are connected in parallel. On the other hand, as shown in FIG. 12, the first current collector terminals 30A and a plurality of the second current collector terminals 30B may be arranged so as to overlap each other in the laminating direction D_{L} of the electrode body. In this case, a battery group joined by the first current collector terminals and a battery group joined by the second current collector terminals 30B are connected in series.

The present disclosure is not limited to the above embodiments. The above embodiments are illustrative, and anything having substantially the same configuration as, and having similar functions and effects to, the technical idea described in the claims of the present disclosure is included in the technical scope of the present disclosure.

What is claimed is:

1. A battery comprising:
an electrode body;
a plurality of current collector tabs extending from a side surface portion of the electrode body;
a current collector terminal connected to the current collector tabs; and
a laminate film housing the electrode body and the current collector tabs, wherein:
each of the current collector tabs includes a root portion that is an end portion on the electrode body side, a connection portion for connecting to the current collector terminal, and an intermediate portion connecting the root portion and the connection portion;
the current collector tabs include a laminated connection portion in which the respective connection portions of the current collector tabs are laminated in a thickness direction;
the current collector terminal includes an inner surface facing the side surface portion of the electrode body, and a side surface disposed along an outer edge of the inner surface;
the laminate film is disposed on the side surface of the current collector terminal;
a main surface of the laminated connection portion is joined to the inner surface; and
in a plan view in a laminating direction of the electrode body, the current collector terminal includes a base portion including a first end portion corresponding to a position of the inner surface and a second end portion opposite to the first end portion, and a protruding portion protruding from the base portion to an opposite side of the base portion from the electrode body.

2. The battery according to claim 1, wherein, in a sectional view in the laminating direction of the electrode body, the intermediate portion includes a curved structure in which the intermediate portion is curved such that parts of the intermediate portion face each other.

3. The battery according to claim 1, wherein:
the current collector terminal includes a first protruding portion and a second protruding portion as the protruding portion; and
in the plan view in the laminating direction of the electrode body, when a direction in which the electrode body and the current collector terminal face each other is D₁, a direction orthogonal to the direction D₁ is D₂, and an axis that is parallel to the direction D₁ and passes through a midpoint of the current collector terminal in the direction D₂ is AX,
the first protruding portion is disposed in one area of the current collector terminal partitioned by the axis AX, and
the second protruding portion is disposed in another area of the current collector terminal partitioned by the axis AX.

4. A battery module in which multiple batteries are stacked, wherein each of the batteries is the battery according to claim 1.

5. A battery module in which multiple batteries are stacked, wherein:
each of the batteries is the battery according to claim 3;
the battery module includes a battery A, a battery B, and a battery C as the batteries;
the battery A, the battery B, and the battery C are stacked in succession;
the first protruding portion of the battery A, the first protruding portion of the battery B, and the first protruding portion of the battery C are arranged so as to at least partially overlap each other in the plan view in the laminating direction of the electrode body;
the second protruding portion of the battery A, the second protruding portion of the battery B, and the second protruding portion of the battery C are arranged so as to at least partially overlap each other in the plan view in the laminating direction of the electrode body;
the first protruding portion of the battery B is joined to the first protruding portion of the battery A, and is not joined to the first protruding portion of the battery C; and
the second protruding portion of the battery B is not joined to the second protruding portion of the battery A, and is joined to the second protruding portion of the battery C.
